(19) United States
(12) Patent Application Publication
(10) Pub. No.: US 2019/0255475 A1
(43) Pub. Date: Aug. 22, 2019

(54) HONEYCOMB SEGMENT JOINED BODY AND METHOD FOR PRODUCING THE SAME, AND DUST COLLECTING FILTER

(71) Applicant: NGK INSULATORS, LTD., Nagoya-Shi (JP)

(72) Inventors: Yutaka ISHII, Nagoya-Shi (JP); Yoshihiro SATO, Nagoya-Shi (JP); Michio SUZUKI, Nagoya-Shi (JP); Yasutaka WATANABE, Nagoya-Shi (JP)

(73) Assignee: NGK INSULATORS, LTD., Nagoya-Shi (JP)

(21) Appl. No.: 16/266,355

(22) Filed: Feb. 4, 2019

(30) Foreign Application Priority Data
Feb. 21, 2018 (JP) 2018-029017

(51) Int. Cl. B01D 46/24

(52) U.S. Cl. CPC B01D 46/2466; B01D 2279/30; B01D 2046/2481; B01D 46/2455

(57) ABSTRACT

A honeycomb segment joined body includes a plurality of honeycomb segments; and joining layers for bonding side surfaces of the plurality of honeycomb segments. Each of the joining layers is a cured product of a pasty joining material, and has a standard deviation of joined widths of 0.30 or less. The honeycomb segment joined body is produced by applying pressurization with vibration when joining side surfaces of a plurality of honeycomb segments using a pasty joining material.

This application claims the benefit under 35 USC § 119(a)-(d) of Japanese Application No. 2018-029017 filed Feb. 21, 2018, the entirety of which is incorporated herein by reference.

### FIELD OF THE INVENTION

The present invention relates to a honeycomb segment joined body and a method for producing the same, as well as a dust collecting filter.

### BACKGROUND OF THE INVENTION

A honeycomb structure is widely used as a dust collecting filter for an exhaust gas, for example a diesel particulate filter (DPF) for trapping and removing particulate matters (particulates) contained in an exhaust gas from diesel engines or the like. The honeycomb structure used for such an application is subjected to a rapid temperature change and local heat generation of an exhaust gas and tends to generate an uneven temperature distribution in the honeycomb structure, which cause problems such as cracks.

Thus, to solve such problems, the honeycomb structure is formed from a plurality of honeycomb segments so as to form a structure in which the respective honeycomb segments are joined and integrated with joining layers, whereby thermal stress acting on the honeycomb structure is relieved with the joining layers (for example, see Patent Document 1).

The honeycomb structure (honeycomb segment joined body) formed by joining a plurality of honeycomb segments as described above is usually produced by using an arrangement reference jig 30 having two planes (a first plane 31 and a second plane 32) forming a right angle as shown in FIG. 1, arranging a plurality of honeycomb segments 20 side by side at predetermined positions on the arrangement reference jig 30 in a direction parallel to the first plane 31 and a direction parallel to the second plane 32, via a joining material in the form of paste, and then drying and curing the joining material 21 in the form of paste. It should be noted that the first plane 31 and the second plane 32 may be optionally provided with pads 33 that are brought into contact with the honeycomb segments 20.

FIG. 2 shows an ideal arrangement state after arranging all 16 honeycomb segments when the 16 honeycomb segments 1 to 16 in total are arranged in four rows in a direction parallel to the first plane 31 and in a direction parallel to the second plane 32, respectively. In FIG. 2, reference numerals 1 to 16 labelled for the honeycomb segments indicate the order of arrangement, and it is thus general that the honeycomb segments are sequentially arranged in the form of steps from the firstly arranged honeycomb segment 1 to the finally arranged honeycomb segments 16.

When actually arranging the honeycomb segments by the above method, it is difficult to obtain the ideal arrangement state as shown in FIG. 2, and it is easy to bring about a state where positional deviation occurs in the honeycomb segments, due to variations in the joined widths.

Therefore, a method for arranging honeycomb segments is proposed in which when arranging a new honeycomb segment at a predetermined position in the process of sequentially arranging the honeycomb segments at predetermined positions, a pressurizing force is applied to the honeycomb segment which has already been arranged (e.g., Patent Document 2).

### CITATION LIST

### Patent Literatures

Patent Document 1: Japanese Patent Application Publication No. 2000-279729 A

Patent Document 2: WO 2008/140095 A1

### SUMMARY OF THE INVENTION

### Technical Problem

However, according to the method for applying the pressurizing force, repulsion against applied pressure (spring back) is generated when releasing the applied pressure. Therefore, there is a problem that joining defects such as sink marks tends to occur. Further, the joining material in the form of paste is a dilatant fluid, so that it generates resistance to the applied pressure to increase a viscosity of the joining material, and as a result, variations in joined widths also tend to occur.

The present invention has been made to solve the above problems. An object of the present invention is to provide a honeycomb segment joined body and a method for producing the same that have decreased variations in joined widths and good joining quality.

Another object of the present invention is to provide a dust collecting filter including a honeycomb segment joined body having the above features.

### Solution to Problem

As a result of extensive studies to solve the above problems, the present inventors have found that application of vibration when applying a pressure can suppress an increase in a viscosity of the joining material during the spring back and the applying of the pressure, and have completed the present invention.

Thus, the present invention relates to a method for producing a honeycomb segment joined body, comprising applying pressurization with vibration when joining side surfaces of a plurality of honeycomb segments using a pasty joining material.

Further, the present invention relates to a honeycomb segment joined body comprising a plurality of honeycomb segments; and joining layers for bonding side surfaces of the plurality of honeycomb segments, wherein each of the joining layers is a cured product of a pasty joining material, and has a standard deviation of joined widths of 0.30 or less.

Furthermore, the present invention relates a dust collecting filter comprising the honeycomb segment joined body.

### Advantageous Effects of Invention

According to the present invention, it is possible to provide a honeycomb segment joined body and a method for producing the same that have decreased variations in joined widths and good joining quality.

Further, according to the present invention, it is possible to provide a dust collecting filter having a honeycomb segment joined body having the above features.

### BRIEF DESCRIPTION OF THE DRAWINGS

FIG. 1 is an explanatory view showing a method for arranging honeycomb segments using an arrangement reference jig.

FIG. 2 is an explanatory view showing an arranged state after all honeycomb segments have been arranged.

FIG. 3 is an explanatory view showing a state of a process of arranging honeycomb segments.

FIG. 4 is an explanatory view showing a state of a process of pressurization with vibration for honeycomb segments.

FIG. 5 is a view showing measurement positions for a joined width of joining layer in Example.

### DETAILED DESCRIPTION OF THE INVENTION

Hereinafter, preferred embodiments of a honeycomb segment joined body and a method for producing the same as well as a dust collecting filter according to the present invention will be specifically described, but the present invention should not be construed as being limited thereto, and various modifications and improvements may be made based on the knowledge of a person skilled in the art, without departing from the spirit of the present invention. A plurality of elements disclosed in each embodiment can form various inventions by proper combinations. For example, some elements may be deleted from all the elements described in the embodiments, or elements of different embodiments may be optionally combined.

A method for producing a honeycomb segment joined body according the present embodiment includes applying pressurization with vibration when bonding side surfaces of a plurality of honeycomb segments using a pasty joining material.

Since the pasty joining material contains fillers such as inorganic fibers and inorganic particles, the fillers tend to be present in a non-uniform state in the pasty joining material. If the honeycomb segments are joined under pressure using the pasty joining material in such a state, the spring back will be generated, so that joining defects such as sink marks tend to occur.

However, in the method for producing the honeycomb segment joined body according to the present embodiment, the vibration is applied during the joining under pressure for the honeycomb segments, so that the fillers in the pasty joining material becomes easy to flow due to the vibration. As a result, in the method for producing the honeycomb segment joined body according to the present embodiment, it is difficult for the spring back to occur, so that generation of joining defects such as sink marks can be suppressed.

As used herein, the wording “sink mark” refers to a defect (for example, a cavity, a gap, or the like) generated due to shrinkage when curing the pasty joining material.

Further, the pasty joining material is a dilatant fluid which exhibits resistance to applied pressure and has a property in which viscosity of the pasty joining material becomes higher. Therefore, when joining the side surfaces of a plurality of honeycomb segments using the pasty joining material, merely pressurizing does not sufficiently spread the pasty joining material on the joining surfaces, so that variations in the joined widths are liable to occur.

However, in the method for producing the honeycomb segment joined body according to the present embodiment, the vibration is applied during the joining under pressure for the honeycomb segments, so that the viscosity of the pasty joining material is hardly increased. As a result, in the method for producing the honeycomb segment joined body according to the present embodiment, the pasty joining material can be sufficiently spread over the joining surfaces, so that variations in the joined widths can be suppressed.

The pressurization with vibration may be applied after all the honeycomb segments are arranged in predetermined positions, but it may be applied after each honeycomb segment is arranged at a predetermined position. It is preferable to apply the pressurization with vibration after arranging all the honeycomb segments at the predetermined positions, in terms of the productivity of the honeycomb segment joined body.

Conditions for the pressurization with vibration are not particularly limited, and they may be adjusted as needed according to the type of pasty joining material or the like.

In one embodiment, the pressurization with vibration is preferably carried out under conditions of a frequency of from 0.5 to 100 Hz and an amplitude of from 1 to 80 mm, and more preferably carried out under conditions of a frequency of from 1 to 50 Hz and an amplitude of from 1 to 60 mm. By carrying out the pressurization with vibration under such conditions of vibration frequency and amplitude, the generation of joining defects such as sink marks and variations in joined widths can be suitably suppressed.

The pressure applied is not particularly limited, but it may preferably be from 29 to 59 kPa.

The method for applying the pressurization with vibration is not particularly limited as long as the honeycomb segments can be pressurized and held while being vibrated to a predetermined pressurizing force.

In one embodiment, the pressurization with vibratory is carried out by dividing it into two or more steps, and the pressurization with vibration is preferably stopped at each interval between the steps. The temporarily stopping of the pressurization with vibration can allow suppression of spring back, and enhance an effect of facilitating sufficient spreading of the pasty joining material onto the joining surfaces. As a result, the generation of joining defects such as sink marks and variations in joined widths can be suppressed.

The holding time of the pressurization with vibration (the total holding time in the case of dividing into two or more steps) may be, but not particularly limited to, preferably from 10 to 100 seconds, and more preferably from 20 to 90 seconds. When the pressurization with vibration is divided into two or more steps, the holding time of each step is not particularly limited, but it may preferably be from 5 to 50 seconds, and more preferably from 10 to 45 seconds.

Non-limiting examples of the pasty joining material that can be used include those known in the technical field.

In one embodiment, the pasty joining material contains a filler, a binder, and water. Further, the pasty joining material can optionally contain various components such as a dispersing agent.

Examples of the filler include fibers or particles formed from ceramic raw materials. Examples of the ceramic raw material include silicon carbide, silicon-silicon carbide based composite materials, cordierite-forming raw materials, cordierite, mullite, alumina, titania, spinel, silicon carbide-cordierite composite materials, lithium aluminum silicate, aluminum titanate, iron-chromium-aluminum alloys and the like. These can be used alone or in combination of two or more. Among them, silicon carbide or the silicon-silicon carbide based composite materials are preferable. As used herein, the term “cordierite-forming raw material” is a ceramic raw material which is formulated so as to have a chemical composition in which silica is in a range of from 42 to 56% by mass, alumina is in a range of from 30 to 45% by mass, and magnesia is in a range of from 12 to 16% by mass, and which is fired to form cordierite. In the case of the silicon-silicon carbide based composite material, the ceramic material is a mixture of silicon carbide powder and metallic silicon powder. The content of the ceramic raw material may preferably be from 40 to 90% by mass relative to the total forming raw material.

Examples of the binder include inorganic binders such as colloidal silica (silica sol), alumina sol and montmorillonite; and various water-absorbing resins such as methyl cellulose, carboxymethyl cellulose, hydroxypropoxyl cellulose, hydroxyethyl cellulose, polyvinyl alcohol (PVA), and polyvinyl butyral (PVB). These can be used alone or in combination of two or more.

The pasty joining material can be produced by mixing and kneading the above components using a kneader such as a mixer to form a paste.

The honeycomb segments are not particularly limited, and those known in the technical field can be used.

In one embodiment, the honeycomb segments include a ceramic raw material, a binder, a surfactant, and a pore former.

The ceramic raw material and the binder are not particularly limited, and various materials listed above can be used.

Non-limiting examples of the surfactant that can be used include PEG oleate, ethylene glycol, dextrin, fatty acid soaps, polyalcohol and the like. These can be used alone or in combination of two or more.

The pore former is not particularly limited as long as it forms pores after firing, including, for example, starch, foaming resins, water absorbent resins, silica gel, carbon and the like. These can be used alone or in combination of two or more.

The honeycomb segment can be produced by adding the binder, the surfactant, the pore former, water and the like to the ceramic raw material and mixing them to prepare a green body, extruding the green body so as to have a predetermined honeycomb shape, and drying the extruded product with microwave, hot air or the like, and then firing it.

Further, in each of the honeycomb segments, plugged portions for plugging one end face of the cells may be formed on any one of two end faces of the honeycomb segment. In general, adjacent cells are alternately plugged such that one end face and the other end face present complementary plaid patterns. The plugged portions are preferably made of the same material as that of the honeycomb segment in order to decrease a thermal expansion difference between the plugged portions and the honeycomb segment.

When forming the plugged portions for the cells, the firing may be performed before forming the plugged portions for the cells, or may be performed with the firing of the plugged portions after forming the plugged portions for the cells. The plugged portions for the cells may be formed by a method known in the art. More particularly, the method is carried out by attaching a sheet onto the end face of each honeycomb segment, forming holes at positions corresponding to the cells to be plugged in the sheet, and in a state where the sheet is attached, immersing the end face of the honeycomb segment in a plugging slurry obtained by forming a slurry of components for the plugged portions, and filling the open ends of the cells to be plugged with the plugging slurry through the holes formed in the sheet, and drying and/or firing it to cure it.

The shape of the honeycomb segment is not particularly limited and may be various shapes such as a triangular pillar shape, a quadrangular pillar shape, a hexagonal pillar shape, and the like.

In one embodiment, the shape of the honeycomb segment is preferably the quadrangular pillar shape. The honeycomb segment having such a shape allows easy production of the honeycomb segment joined body.

The method for producing the honeycomb segment joined body according to the present embodiment can be carried out according to a known method with the exception that vibration is applied during joining under pressure for the honeycomb segments.

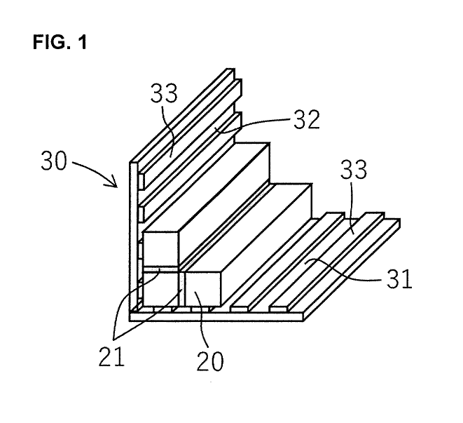

In one embodiment, a plurality of honeycomb segments 20 are joined by using an arrangement reference jig 30 having two planes (a first plane 31 and a second plane 32) forming a right angle as shown in FIG. 1, arranging the plurality of honeycomb segments 20 side by side at predetermined positions on the arrangement reference jig 30 in a direction parallel to the first plane 31 and a direction parallel to the second plane 32, via a pasty joining material, and then applying pressurization with vibration to join the honeycomb segments.

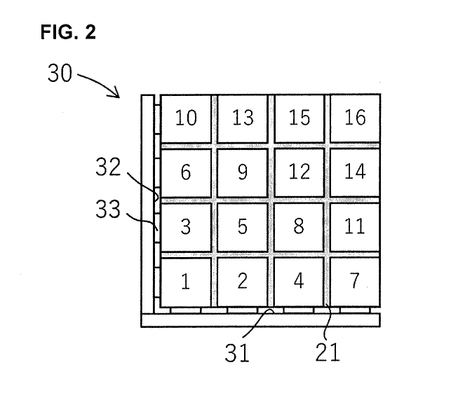

The arrangement order of the honeycomb segments is not particularly limited. For example, as shown in FIG. 2, 16 honeycomb segments 1 in total may be arranged in four rows in a direction parallel to the first plane 31 and in a direction parallel to the second plane 32, respectively, in the order of their reference numerals.

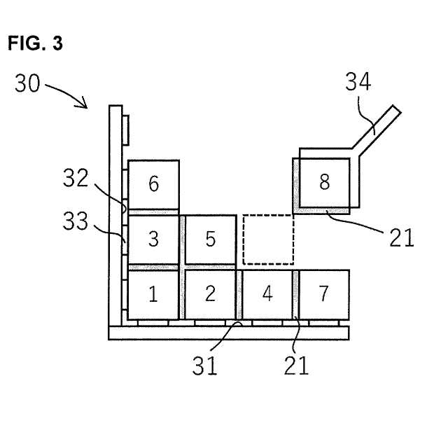

FIG. 3 shows a state where a honeycomb segment 8 is arranged as an example. To arrange the honeycomb segments, it is preferable to use an arranging means 34 which can hold the honeycomb segment 8 by gripping, sucking or the like and move it to a predetermined arrangement position. Prior to arrangement of the honeycomb segment 8 at the predetermined position indicated by a dotted line, a pasty joining material 21 is applied to side surfaces of the honeycomb segment 8 to be newly arranged, which side surfaces are opposite to those of the honeycomb segment 4 and the honeycomb segment 5 which have been already arranged. An amount of the pasty joining material 21 applied is an amount that can fill a gap between the honeycomb segment 8 and the honeycomb segment 4/the honeycomb segments 5 which are adjacent to each other, when the honeycomb segment 8 is set at the predetermined position, that is, an amount equal to or somewhat more than a volume of the gap. If the applied amount is too low, the joining material is not sufficiently filled between the honeycomb segment 8 and the honeycomb segment 4 and the honeycomb segment 5, so that any satisfactory joined state cannot be obtained.

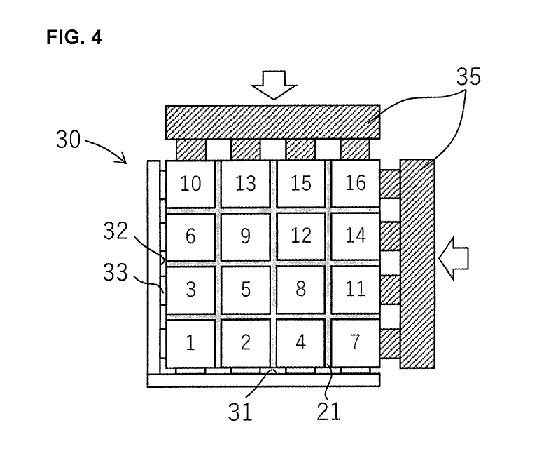

After arranging all of the honeycomb segments 1 to 16 at predetermined positions by the same arrangement method as described above, the honeycomb segments 1 to 16 are pressurized with vibration in a vertical direction toward the first plane 31 and in the horizontal direction toward the flat surface 32, respectively, using a vibration-pressurizing means 35 as shown in FIG. 4.

The vibration-pressurizing means 35 is not particularly limited, and a vibration exciter known in the art may be used. The vibration exciter may be of any type such as electric type or fluid pressure (including pneumatic, hydraulic, hydraulic) type. However, in view of controllability, responsiveness, compactness or the like, a servo type vibration exciter is preferably used.

After pressurization with vibration, the pasty joining material 21 is cured by drying it to form a joining layer. Although the drying of the pasty joining material 21 may be carried out while applying a pressurizing force, the vibration is preferably stopped. The drying condition may be optionally adjusted depending on the type of pasty joining material 21 to be used, and the pasty joining material is preferable dried at 60 to 170° C. for 0.5 to 6.0 hours.

The honeycomb segment joined body in which all of the honeycomb segments 1 to 16 are joined via the joining layers may be processed into a desired shape such as a cylindrical shape such as by grinding the outer peripheral portion as required. In this case, the outer peripheral wall is removed by the processing, so that the partition walls and the cells inside the outer peripheral wall are exposed. Therefore, the outer peripheral wall is preferably reformed by covering the exposed surfaces with a coating material or the like.

The honeycomb segment joined body according to the present embodiment produced as described above is a honeycomb segment joined body including a plurality of honeycomb segments 20; and joining layers for bonding side faces of the plurality of honeycomb segments 20. In the honeycomb segment joined body, each joining layer is a cured product of the pasty joining material, and a standard deviation of the joined widths is 0.30 or less, and preferably 0.20 or less. The honeycomb segment joined body has the standard deviation of the joined widths of 0.30 or less, so that variations in the joined widths are extremely low. Further, the honeycomb segment joined body suppresses the spring back during the joining, so that joining defects such as sink marks are very few.

The honeycomb segment joined body according to this embodiment can be used as a dust collecting filter such as DPF and GPF. When used as the dust collecting filter, one end face of two end faces of the honeycomb segment is preferably provided with a plugged portion for plugging one end portion of each cell, as described above. In general, adjacent cells are alternately plugged such that one end face and the other end face present complementary plaid patterns.

When a fluid containing particulates such as soot is vented from one end face of the honeycomb segment joined body formed of the plugged honeycomb segments, the fluid flows inside the honeycomb segment joined body from cells having unplugged end portions on the one end portion side, passes through the porous partition walls each having a filtering capability, and enters the other flow holes for which the other end face side of the honeycomb segment joined body is not plugged. When passing through the partition walls, the particulates in the fluid are trapped by the partition walls, and a cleaned fluid from which particulates have been removed is discharged from the other end face of the honeycomb structure.

### EXAMPLES

Hereinafter, the present invention will be more specifically described with reference to Examples, but the present invention is not limited to these Examples.

### (Production of Honeycomb Segment)

Silicon carbide powder and metallic silicon powder were mixed in a mass ratio of 80:20, to which a binder (methyl cellulose and hydroxypropoxyl cellulose), a pore former (a foaming resin and a water absorbent resin), a surfactant (PEG oleate) and water were added to prepare a green body having plasticity. The resulting green body was extruded and dried with microwave and hot air to produce a rectangular pillar shaped honeycomb segment formed body having a square shape with one side of 37 mm, in a cross section orthogonal to the central axis.

One end portion of each cell was then plugged by filling it with a plugging slurry such that the end face of the honeycomb segment formed body presented a plaid pattern. It should be noted that for the plugging slurry, the same material as the raw material of the honeycomb segment was used. After drying plugging slurry, the honeycomb segment formed body was degreased at 400° C. and then fired in an Ar inert atmosphere at 1450° C. to obtain a honeycomb segment.

### (Preparation of Pasty Joining Material)

60% by mass of ceramics raw material (silicon carbide, cordierite and alumina), 18% by mass of inorganic binder (silica sol and montmorillonite), 5% by mass of organic binder (carboxymethyl cellulose and foaming resin) and 17% by mass of water were mixed using a mixer to obtain a pasty joining material.

### Example 1

A honeycomb segment 1 was disposed on an arrangement reference jig 30 having two planes (a first plane 31 and a second plane 32) forming a right angle as shown in FIG. 1, and a pasty joining material 21 was then applied to a side surface of a honeycomb segment 2 facing a side surface of the honeycomb segment 1 and arranged at a predetermined position. In the same way, honeycomb segments 3 to 16 were disposed at predetermined positions via the pasty joining material 21, and pressurization with vibration was performed using a vibration exciter. Here, the pressurization with vibration was performed by dividing it into two steps, and the pressurization with vibration was stopped at each interval between the steps. The pressurization with vibration in each step was carried out under conditions of a vibration frequency of 15 Hz, an amplitude of 0.42 mm, a pressurizing force of 39 kPa, a holding time of the first step of 10 seconds, and a holding time of the second step of 10 seconds. Subsequently, the pasty joining material was cured by drying it at 140° C. for 2 hours to obtain a honeycomb segment joined body.

An outer periphery of the honeycomb segment joined body was cut such that a cross section perpendicular to the center axis of the resulting honeycomb segment joined body had a circular shape.

### Comparative Example 1

A honeycomb segment joined body was obtained in the same method as that of Example 1 with the exception that pressurization was performed in place of the pressurization with vibration. Here, the pressurization was carried out under conditions of a pressurizing force of 39 kPa, a holding time of a first step of 18 seconds, and a holding time of a second step of 18 seconds.

The honeycomb segment joined bodies produced in Example and Comparative Example as described above were evaluated as follows:

### (Generation Rate of Sink Mark)

The presence or absence of sink marks on the end faces and the outer peripheral surfaces of honeycomb segment joined bodies (a number of samples of 30) prepared in the above Example and Comparative Example was visually evaluated. The results are shown in Table 1. In Table 1, for a sink mark on the end face, the sink mark generated between end faces of individual honeycomb segments is expressed as an end face edge portion, and the sink mark generated between apexes of individual honeycomb segments is expressed as an end face intersection portion.

TABLE 1

| | Generation Rate of Sink Mark (%) | | |
|---|---|---|---|
| | End Face | End Face | Outer |
| | Intersection | Edge | Peripheral |
| | Portion | Portion | Surface |
| Example 1 | 0 | 0 | 0 |
| Comparative Example 1 | 50 | 50 | 12 |

As shown in Table 1, in the honeycomb segment joined body according to Example 1, no sink mark was generated in all of the end faces and the outer peripheral surface, whereas in the honeycomb segment joined body according to Comparative Example 1, generation of sink marks was observed.

### (Joined Width)

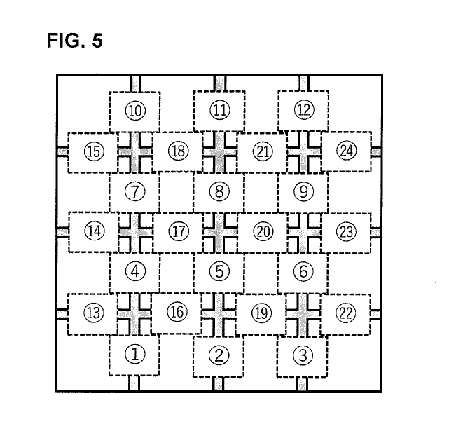

Joined widths of the joining layers on the end faces of the honeycomb segment joined bodies produced in the above Example and Comparative Example were measured. The measurement of each honeycomb segment joined body was carried out at 24 positions as shown in FIG. 5. The results are shown in Table 2. In Table 2, the unit of measured values and average values is mm.

TABLE 2

| Measured Points | Example 1 | Comparative Example 1 |
|---|---|---|
| \textcircled{1} | 0.89 | 2.08 |
| \textcircled{2} | 0.90 | 1.61 |
| \textcircled{3} | 1.15 | 1.43 |
| \textcircled{4} | 1.23 | 1.17 |
| \textcircled{5} | 1.28 | 1.13 |
| \textcircled{6} | 1.32 | 1.34 |
| \textcircled{7} | 1.01 | 1.50 |
| \textcircled{8} | 0.95 | 1.49 |
| \textcircled{9} | 1.05 | 0.92 |
| \textcircled{10} | 0.96 | 1.22 |
| \textcircled{11} | 0.70 | 1.33 |
| \textcircled{12} | 1.03 | 2.06 |
| \textcircled{13} | 1.04 | 1.15 |
| \textcircled{14} | 1.00 | 1.26 |
| \textcircled{15} | 0.77 | 1.22 |
| \textcircled{16} | 1.13 | 0.87 |
| \textcircled{17} | 1.18 | 0.94 |
| \textcircled{18} | 1.27 | 0.94 |
| \textcircled{19} | 1.24 | 0.74 |
| \textcircled{20} | 1.27 | 1.10 |
| \textcircled{21} | 1.02 | 0.70 |
| \textcircled{22} | 1.00 | 1.25 |
| \textcircled{23} | 0.89 | 1.16 |
| \textcircled{24} | 0.69 | 0.77 |
| Average | 1.04 | 1.22 |
| Standard Deviation | 0.18 | 0.36 |

As shown in Table 2, it was confirmed that the honeycomb segment joined body according to Example 1 had a lower standard deviation of the joined widths of the joining layers and lower variation in the joined widths than those of the honeycomb joined body according to Comparative Example 1.

As can be seen from the above results, according to the present invention, it is possible to provide a honeycomb segment joined body and a method for producing the same having lower variations in joined widths and good joining quality.

Further, according to the present invention, it is possible to provide a dust collecting filter including the honeycomb segment joined body having the above features.

### DESCRIPTION OF REFERENCE NUMERALS

1-16, 20 honeycomb segment
21 pasty joining material
30 arrangement reference jig
31 first plane
32 second plane
33 pad
34 arrangement means
35 vibration-pressurizing means

1. A method for producing a honeycomb segment joined body, comprising applying pressurization with vibration when joining side surfaces of a plurality of honeycomb segments using a pasty joining material.

2. The method for producing a honeycomb segment joined body according to claim 1, wherein the joining material comprises a dilatant fluid.

3. The method for producing a honeycomb segment joined body according to claim 1, wherein the pressurization with vibration is carried out under conditions of a frequency of from 0.5 to 100 Hz and an amplitude of from 1 to 80 mm.

4. The method for producing a honeycomb segment joined body according to claim 1, wherein the pressurization with vibratory is carried out by dividing it into two or more steps, and the pressurization with vibration is stopped at each interval between the steps.

5. The method for producing a honeycomb segment joined body according to claim 1, wherein the honeycomb segment has a quadrangular pillar shape.

6. A honeycomb segment joined body comprising a plurality of honeycomb segments; and joining layers for bonding side surfaces of the plurality of honeycomb segments,
wherein each of the joining layers is a cured product of a pasty joining material, and has a standard deviation of joined widths of 0.30 or less.

7. The honeycomb segment joined body according to claim 6, wherein the standard deviation of joined widths is 0.20 or less.

8. The honeycomb segment joined body according to claim 6, wherein each of the honeycomb segments has a quadrangular pillar shape.
